(19) United States
(12) Patent Application Publication
(10) Pub. No.: US 2006/0071893 A1
(43) Pub. Date: Apr. 6, 2006

(54) Source driver, electro-optic device, and electronic instrument

(76) Inventors: Tamiko Nishina, Suwa (JP); Katsuhiko Maki, Chino (JP)

Correspondence Address: HARNESS, DICKEY & PIERCE, P.L.C., P.O. BOX 828, BLOOMFIELD HILLS, MI, 48303, US

(21) Appl. No.: 11/242,280

(22) Filed: Oct. 3, 2005

(30) Foreign Application Priority Data
Oct. 4, 2004 (JP) 2004-291573

(51) Int. Cl. G09G 3/36

(52) U.S. Cl. 345/89

(57) ABSTRACT

A source driver which drives a source line of an electro-optic device. The source driver includes: a driving mode setting register which sets a first or a second driving mode; first to m-th level shifters, each of which transforms a signal amplitude of each bit of m-bit display data (m is an integer larger than 1); an Op-Amp which drives a source line based on one grayscale voltage that corresponds to output signals from the first to m-th level shifters, when the first driving mode is set by the driving mode setting register; and a voltage setting circuit which sets a voltage as an output of the Op-Amp, the voltage corresponding to the higher-order n bits of data in the m-bit display data (n<m, and n is an integer), when the second driving mode is set by the driving mode setting register, wherein an input signal of the first to (m-n)-th level shifters among the first to m-th level shifters is fixed, the first to (m-n)-th level shifters transforming a signal amplitude of each bit of the lower-order (m-n) bits of the m-bit display data, when the second driving mode is set.

Japanese Patent Application No. 2004-291573, filed on Oct. 4, 2004, is hereby incorporated by reference in its entirety.

### BACKGROUND OF THE INVENTION

The present invention relates to a source driver, an electro-optic device and an electronic instrument, which include the source driver.

A passive matrix system and an active matrix system are generally known as systems for liquid crystal panels (electro-optic device) used in electronic instruments such as mobile phones, etc.

The passive matrix system has an advantage with its ability to lower the power-consumption, compared to that of the active matrix system, however, at the same time, it has a disadvantage that it is difficult to display multicolor and video images. In contrast, the active matrix system has an advantage that it is suitable for displaying multicolor and video images, at the same time, it has a disadvantage that it is difficult to lower the power-consumption.

In recent years, there has been an increasing demand for portable electronic instruments such as mobile phones etc., to display multicolor and video images, in order for them to provide high quality images. Therefore, liquid crystal panels with the active matrix system are replacing liquid crystal panels with the passive matrix system that have been employed so far.

In the case of driving such active matrix liquid crystal panels, an impedance transformer, which functions as an output buffer, is installed in a source driver that drives source lines of the liquid crystal panel. An operational amplifier (Op-Amp), in which a voltage follower is connected, is chosen for the impedance transformer. Hence the high level of driving power can be obtained, while the power consumed by the operational current of the operational amplifier increases. This is why the source driver's driving mode includes a power saving driving mode besides the normal driving mode, where the power saving driving mode has the ability to reduce unnecessary power consumption by operating in reduced colors. JP-A-2004-12944 is an example of related art.

In the source driver, the power voltage (for example 1.8V) in the control logic system that takes in, drives and controls display data, and the power voltage (for instance 5.0V) in the driving system that drives the source lines, are different from one another. Thus the source driver includes a level shifter for transforming voltage levels, in order to generate driving voltages that correspond with the display data.

It has been common practice that the level shifter performs the transformation of the voltage level, regardless of the driving mode such as normal driving mode and power saving driving mode, etc. Consequently, in the power saving driving mode, the generation of through current brought by the transformation of voltage level involved a problem of unnecessary current consumption. This is because even though it is the data of, for example, the most significant bit in display data that is necessary in the power saving driving mode, voltage levels of signals of unnecessary lower-order bits are transformed.

Moreover, various efforts to achieve low power consumption in various parts of Op-Amps have been made for source drivers so far. Hence, in order to further lower the power consumption, it is more effective to lower the power consumption of the level shifters that use the power voltage in the driving system, which is of a high voltage, rather than that of the control logic system that is of a low voltage.

### SUMMARY

According to a first aspect of the invention, there is provided a source driver which drives a source line of an electro-optic device, the source driver comprising:

a driving mode setting register which sets a first or a second driving mode;

first to m-th level shifters, each of which transforms a signal amplitude of each bit of m-bit display data (m is an integer larger than 1);

an Op-Amp which drives a source line based on one grayscale voltage that corresponds to output signals from the first to m-th level shifters, when the first driving mode is set by the driving mode setting register; and

a voltage setting circuit which sets a voltage as an output of the Op-Amp, the voltage corresponding to the higher-order n bits of data in the m-bit display data (n<m, and n is an integer), when the second driving mode is set by the driving mode setting register,

wherein an input signal of the first to (m-n)-th level shifters among the first to m-th level shifters is fixed, the first to (m-n)-th level shifters transforming a signal amplitude of each bit of the lower-order (m-n) bits of the m-bit display data, when the second driving mode is set.

According to a second aspect of the invention, there is provided a source driver which drives a source line of an electro-optic device, the source driver comprising:

a driving mode setting register which sets a first or a second driving mode;

first to m-th latches which take m-bit display data at a timing of a rise edge or a fall edge of a latch clock (m is an integer larger than 1);

first to m-th level shifters, each of which transforms a signal amplitude of each bit of the m-bit display data taken by the first to m-th latches;

an Op-Amp which drives a source line based on one grayscale voltage that corresponds to output signals from the first to m-th level shifters, when the first driving mode is set by the driving mode setting register; and

a voltage setting circuit which sets a voltage as an output of the Op-Amp, the voltage corresponding to the higher-order n bits of data in the m-bit display data (n<m, and n is an integer), when the second driving mode is set by the driving mode setting register, wherein a latch clock of the first to (m-n)-th latches among the first to m-th latches is fixed, the first to (m-n)-th latches taking in data of each bit in the lower-order (m-n) bits of the m-bit display data, when the second driving mode is set.

According to a third aspect of the invention, there is provided a source driver which drives a source line of an electro-optic device, the source driver comprising:

a driving mode setting register which sets a first or a second driving mode;

first to m-th level shifters, each of which transforms a signal amplitude of each bit of m-bit display data (m is an integer larger than 1);

an Op-Amp which drives a source line based on one grayscale voltage that corresponds to output signals from the first to m-th level shifters, when the first driving mode is set by the driving mode setting register; and

a voltage setting circuit which sets a voltage as an output of the Op-Amp, the voltage corresponding to the higher-order n bits of data in the m-bit display data (n<m, and n is an integer), when the second driving mode is set by the driving mode setting register,

wherein supply of a higher-potential-side power voltage or a lower-potential-side power voltage of the first to (m-n)-th level shifters among the first to m-th level shifters is stopped, the first to (m-n)-th level shifters transforming a signal amplitude of each bit in the lower-order (m-n) bits of the m-bit display data, when the second driving mode is set.

According to fourth aspect of the invention, there is provided an electro-optic device comprising:

a plurality of source lines;

a plurality of gate lines;

a pixel determined by one of the gate lines and one of the source lines;

a gate driver which scans the gate lines; and

any of the above-described source drivers, which drives each of the source lines.

According to a fifth aspect of the invention, there is provided an electronic instrument comprising the above-described electro-optic device.

### BRIEF DESCRIPTION OF THE SEVERAL VIEWS OF THE DRAWING

The invention will be described with reference to the accompanying drawings, wherein like numbers refer to like elements, and wherein:

FIG. 1 is a block diagram of a display device including an electro-optic device in which a source driver in the embodiment is applied;

FIG. 2 is a block diagram of an example structure of the source driver in FIG. 1;

FIG. 3 is a block diagram of an example structure of a gate driver in FIG. 1;

FIG. 4 is a block diagram of a main part of a source driver in a first example structure in the embodiment;

FIG. 5 is an explanatory drawing of a driving mode setting register;

FIG. 6 is a drawing showing a specific example structure of a circuit per one output in FIG. 4;

FIG. 7 is a drawing showing a specific example structure of a circuit per one output in FIG. 4;

FIG. 8 is a block diagram of a main part of a source driver in a second example structure in the embodiment;

FIG. 9 is a drawing showing a specific example structure of a circuit per one output in FIG. 8;

FIG. 10 is a block diagram of a main part of a source driver in a third example structure in the embodiment;

FIG. 11 is a drawing showing a specific example structure of a circuit per one output in FIG. 10; and

FIG. 12 is a block diagram of an example structure of an electronic instrument in the embodiment.

### DETAILED DESCRIPTION OF THE EMBODIMENTS

The advantage of the invention is to provide a source driver that has the ability to reduce the power consumption, brought by the transformation of the level shifter, according to the driving mode, as well as to provide an electro-optic device and an electronic instrument including the source driver.

According to one embodiment of the invention, there is provided a source driver which drives a source line of an electro-optic device, the source driver comprising:

a driving mode setting register which sets a first or a second driving mode;

first to m-th level shifters, each of which transforms a signal amplitude of each bit of m-bit display data (m is an integer larger than 1);

an Op-Amp which drives a source line based on one grayscale voltage that corresponds to output signals from the first to m-th level shifters, when the first driving mode is set by the driving mode setting register; and

a voltage setting circuit which sets a voltage as an output of the Op-Amp, the voltage corresponding to the higher-order n bits of data in the m-bit display data (n<m, and n is an integer), when the second driving mode is set by the driving mode setting register,

wherein an input signal of the first to (m-n)-th level shifters among the first to m-th level shifters is fixed, the first to (m-n)-th level shifters transforming a signal amplitude of each bit of the lower-order (m-n) bits of the m-bit display data, when the second driving mode is set.

In the above aspect of the invention, the first or the second driving mode is specified by the driving mode setting register. When the first driving mode is specified, the Op-Amp drives the source lines based on one grayscale voltage that corresponds to the output signals of the first to m-th level shifters. When the second driving mode is specified, the voltage setting circuit sets the voltage that corresponds to the data of the higher-order n bits of the display data to the output of the Op-Amp. Here, the input signals of the first to (m-n)-th level shifters, out of the first to m-th level shifters, each of which transforms a signal amplitude of each bit in the lower-order (m-n) bits of the display data, is fixed.

In the second driving mode, lower power consumption is achieved by reducing the colors and omitting the drives by the Op-Amps. The data of the lower-order (m-n) bits of the display data is therefore unnecessary. In the above aspect of the invention, the input signals of the level shifters, which correspond to the lower-order (m-n) bits of the display data, are fixed in this second driving mode. Therefore, the power consumption, brought by transforming the signal amplitude of each bit in the lower-order (m-n) bits of the display data, can be lowered

According to one embodiment of the invention, there is provided a source driver which drives a source line of an electro-optic device, the source driver comprising:

a driving mode setting register which sets a first or a second driving mode;

first to m-th latches which take in m-bit display data at a timing of a rise edge or a fall edge of a latch clock (m is an integer larger than 1);

first to m-th level shifters, each of which transforms a signal amplitude of each bit of the m-bit display data taken by the first to m-th latches;

an Op-Amp which drives a source line based on one grayscale voltage that corresponds to output signals from the first to m-th level shifters, when the first driving mode is set by the driving mode setting register; and

a voltage setting circuit which sets a voltage as an output of the Op-Amp, the voltage corresponding to the higher-order n bits of data in the m-bit display data (n<m, and n is an integer), when the second driving mode is set by the driving mode setting register,

wherein a latch clock of the first to (m-n)-th latches among the first to m-th latches is fixed, the first to (m-n)-th latches taking in data of each bit in the lower-order (m-n) bits of the m-bit display data, when the second driving mode is set.

In the above aspect of the present invention, the first and the second driving modes are specified by the driving mode setting register. When the first driving mode is specified, the Op-Amp drives the source lines based on one grayscale voltage that corresponds to the output signals of the first to m-th level shifters. When the second driving mode is specified, the voltage setting circuit sets the voltage that corresponds to the data of the higher-order n bits of the display data to the output of the Op-Amp. Here, the latch clocks of the first to (m-n)-th latches among the first to m-th level shifters, each of which takes in the data for each bit of the lower-order (m-n) bits of the display data, are fixed.

In the second driving mode, lower power consumption is achieved by reducing the colors and omitting the drives by the Op-Amps. The data of the lower-order (m-n) bits of the display data is therefore unnecessary. In the above aspect of the invention, the input signals of the first to (m-n)-th level shifters are fixed in the second driving mode, since the input signals of the level shifters, which correspond to the lower-order (m-n) bits of the display data, are not refreshed at the first to (m-n)-th latches when signals are taken in. Consequently, the power consumption, brought by transforming the signal's amplitude of each bit of the lower-order (m-n) bits of the display data, can be lowered.

According to one embodiment of the invention, there is provided a source driver which drives a source line of an electro-optic device, the source driver comprising:

a driving mode setting register which sets a first or a second driving mode;

first to m-th level shifters, each of which transforms a signal amplitude of each bit of m-bit display data (m is an integer larger than 1);

an Op-Amp which drives a source line based on one grayscale voltage that corresponds to output signals from the first to m-th level shifters, when the first driving mode is set by the driving mode setting register; and

a voltage setting circuit which sets a voltage as an output of the Op-Amp, the voltage corresponding to the higher-order n bits of data in the m-bit display data (n<m, and n is an integer), when the second driving mode is set by the driving mode setting register,

wherein supply of a higher-potential-side power voltage or a lower-potential-side power voltage of the first to (m-n)-th level shifters among the first to m-th level shifters is stopped, the first to (m-n)-th level shifters transforming a signal amplitude of each bit in the lower-order (m-n) bits of the m-bit display data, when the second driving mode is set.

In the above aspect of the invention, the first and the second driving modes are specified by the driving mode setting register. When the first driving mode is specified, the Op-Amp drives the source lines based on one grayscale voltage that corresponds to the output signals of the first to m-th level shifters. When the second driving mode is specified, the voltage setting circuit sets the voltage that corresponds to the data of the higher-order n bits of the display data to the output of the Op-Amp. Here, the supply of the higher-potential-side power voltage or the lower-potential-side power voltage of the first to (m-n)-th level shifters, out of the first to m-th level shifters, each of which transforms the signal amplitude of each bit in the lower-order (m-n) bits of the display data, ceases.

In the second driving mode, lower power consumption is achieved by reducing the colors and omitting the drives by the Op-Amps. The data of the lower-order (m-n) bits of the display data is therefore unnecessary. According to the above aspect of the invention, the supply of the power voltage of the level shifters, which correspond to the lower-order (m-n) bits of the display data, ceases in this second driving mode. Therefore, the power consumption, brought by transforming the signal amplitude of each bit in the lower-order (m-n) bits of the display data, can be lowered.

This source driver may further comprise:

a voltage selection circuit which selects one grayscale voltage from among 2^{m} types of grayscale voltages, in correspondence to the output signals from the first to m-th level shifters,

wherein the Op-Amp drives the source line based on the grayscale voltage selected by the voltage selection circuit.

Further, in this source driver, the voltage setting circuit may set a voltage as an output of the Op-Amp, the voltage corresponding to the output signals of the (m-n+1)-th to m-th level shifters.

Still further, in this source driver, n may be 1.

In the case where one pixel is configured with Red, Green and Blue components, the pixel can represent eight colors, and the amount of reduced power consumption in the level shifters, brought by transforming the signal amplitude of each bit in the lower-order (m−1) bits of the display data, can be maximized.

According to one embodiment of the invention, there is provided an electro-optic device comprising:

a plurality of source lines;

a plurality of gate lines;

a pixel determined by one of the gate lines and one of the source lines;

a gate driver which scans the gate lines; and

any of the above-described source drivers, which drives each of the source lines.

In the above aspect of the invention, the electro-optic device, which includes the source driver that allows the lowering of the power consumption, by reducing the operating power consumption with color reduction as well as by reducing the level shifter's power consumption, can by provided.

According to one embodiment of the invention, there is provided an electronic instrument comprising the above-described electro-optic device.

Here, the electronic instrument, which includes the source driver that allows the lowering of the power consumption, by reducing the operating power consumption with color reduction as well as by reducing the level shifter's power consumption, can by provided.

The embodiments of the invention will now be described in detail using drawings. The embodiments described hereafter shall not unreasonably limit the content of the invention referred to in the claims. Moreover, it does not necessarily mean that all of the structures described below are an essential requirement of the invention.

1. Electro-optic device

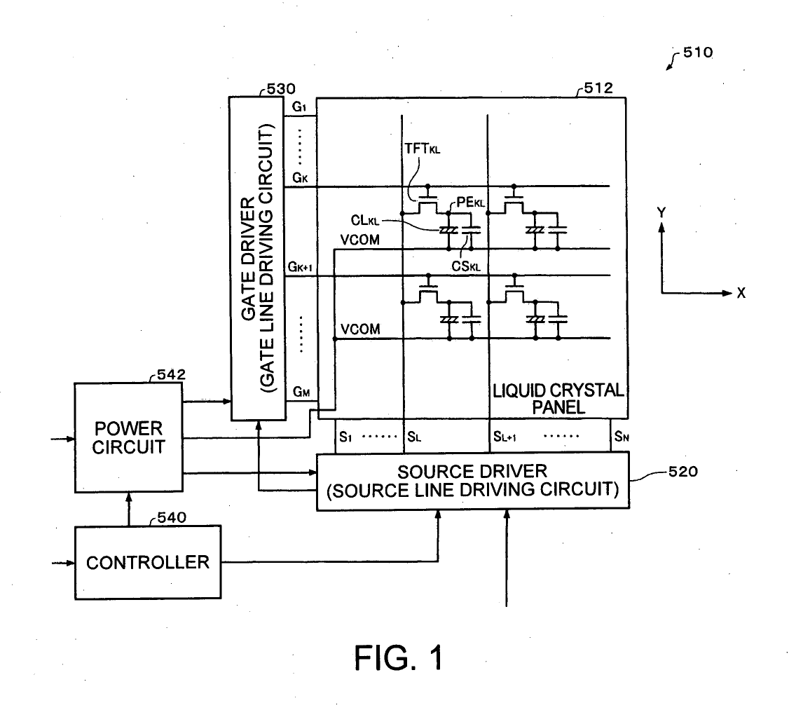

In FIG. 1, a block diagram of a display device including an electro-optic device, in which a source driver in the embodiment is applied, is shown. In FIG. 1, a liquid crystal panel is employed as the electro-optic device. The display device including this liquid crystal panel is called a liquid crystal device in FIG. 1.

The liquid crystal device (in a broader sense, a display device) 510 includes a liquid crystal panel (in a broader sense, a electro-optic device) 512, a source driver (a source line driving circuit) 520, a gate driver (gate line driving circuit) 530, a controller 540, and a power circuit 542. In the liquid crystal device 510, not all the circuit blocks have to be included, and some circuit blocks may be omitted.

Here, the liquid crystal panel 512 includes a plurality of gate lines (in a broader sense, scanning lines), a plurality of source lines (in a broader sense, data lines), and a pixel electrode determined by a gate line and a source line. In other words, the liquid crystal panel 512 includes the plurality of source lines, the plurality of gate lines, and a pixel determined by one of the gate lines and by one of the source lines. In this case, a thin film transistor TFT (in a broader sense, a switching element) is connected to the source line, and by connecting the pixel electrode to this TFT, the liquid crystal device with an active matrix system can be structured.

More specifically, the liquid crystal panel 512 is formed on an active matrix substrate (for instance, a glass substrate). On this active matrix substrate, gate lines G₁ to G_{M} (M is a positive integer larger than 1), which are arrayed in multiple lines in the direction of the Y-axis, each of which is stretched in the direction of the X-axis, and source lines S₁ to S_{N} (N is a positive integer larger than 1), which are arrayed in multiple lines in the direction of the X-axis, each of which is stretched in the direction of the Y-axis, are arranged. Further, at a location corresponding to a cross point of the gate line G_{K} (1≦K≦M, K is a positive integer) and the source line S_{L} (1≦L≦N, L is a positive integer), a thin film transistor TFT_{KL} (in the broader sense, the switching element) is installed.

A gate electrode of the TFT_{KL} is connected to the gate line G_{K}, a source electrode of the TFT_{KL} is connected to the source line S_{L}, and a drain electrode of the TFT_{KL} is connected to a pixel electrode PE_{KL}. Between the pixel electrode PE_{KL} and a facing electrode VCOM (common electrode) that is facing the pixel electrode PE_{KL} across a liquid crystal element (in a broader sense, electro-optic material), a liquid crystal capacitor CL_{KL} (liquid crystal element) and a subsidiary capacitor are formed. Moreover, a liquid crystal is filled in between the active matrix substrate on which the TFT_{KL}, the pixel electrode PE_{KL}, or the like are formed, and the facing substrate on which the facing electrode VCOM is formed. The transmittance of the pixel changes in accordance with an applied voltage between the pixel electrode PE_{KL} and the facing electrode VCOM.

The voltage provided to the facing electrode VCOM is generated by a power circuit 542. Further, facing electrode VCOM band may be formed so that it corresponds to each gate line, instead of being formed on the expanse of the facing substrate.

The source driver 520 drives the source lines S₁ to S_{N} on the liquid crystal panel 512, based on the display data (image data). At the same time, the gate driver 530 sequentially scans the gate lines G₁ to G_{M} on the liquid crystal panel 512.

The controller 540 can control the source driver 520, the gate driver 530, and the power circuit 542, in accordance to what is set by a host such as a Central Processing unit (CPU) (not shown.)

More specifically, the performance of the controller 540 or of the host toward the source driver 520 includes, for example, setting of a driving mode of the source driver 520 and the gate driver 530, supplement of a vertical synchronization signal or a horizontal synchronization signal internally generated. The performance of the controller 540 of the host toward the power circuit 542 includes a control of potential inversion timing of the voltage of the facing electrode VCOM. The source driver 520 supplies a gate driver control signal that corresponds to what is set by the controller 540 or the host to the gate driver 530. The gate driver 530 is controlled based on the gate driver control signal. Further, the potential inversion timing of the voltage of the facing electrode VCOM is transmitted to the source driver 520. The source driver 520 generates an electrode inversion signal POL described later, in synchronization with the potential inversion timing.

The power circuit 542 generates various voltages necessary for driving the liquid crystal panel 512 and the voltage of the facing electrode VCOM, based on the reference voltage supplied externally.

In FIG. 1, the liquid crystal device 510 includes the controller 540. However, the controller 540 may also be installed outside of the liquid crystal device 510. Alternatively, the liquid crystal device 510 may include both the controller 540 and the host. Moreover, the source driver 520, the gate driver 530, the controller 540 and a part of or all of the power circuit 542 may be formed on the liquid crystal panel 512.

1.1 Source Driver

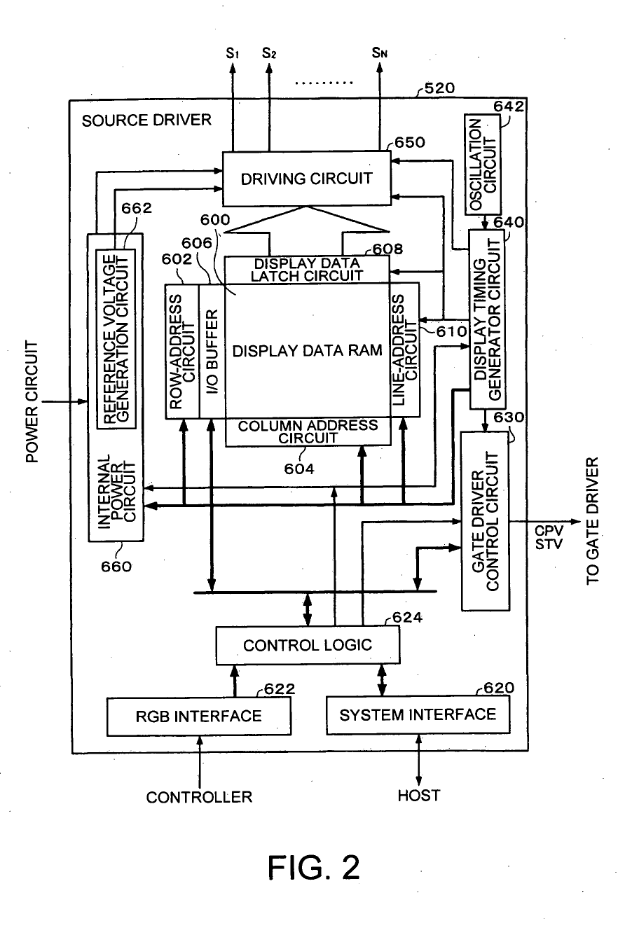

In FIG. 2, an example structure of the source driver in FIG. 1 is shown.

The source driver 520 includes a display data RAM (Random Access Memory) 600 as a display data memory. Display data for still images or video images is stored in the display data RAM 600. The display data of at least one frame can be stored in the display data RAM 600. For example, the host transfers the display data of a still image directly to the source driver 520. Another example may be that the controller 540 transfers the display data of a video image to the source driver 520.

The source driver 520 includes a system interface circuit 620 that serves as an interface with the host. Since the system interface circuit 620 performs an interface processing of signals that are transmitted to and from the host, the host can set control commands or set the display data of the still image in the source driver 520, or can perform a status-read of the source driver 520 or a read-out of the display data RAM 600, through the system interface circuit 620.

The source driver 520 includes an RGB interface circuit 622 in order for it to serve as an interface with the controller 540. Since the RGB interface circuit 622 performs an interface processing of signals that are transmitted to and from the controller 540, the controller 540 can set the display data of the video image through the RGB interface circuit 622.

The system interface circuit 620 and the RGB interface circuit 622 are connected to a control logic 624. The control logic 624 is a circuit block that is responsible for the control of source driver 520 as a whole. The control logic 624 performs a write-in control of the display data that is input through the system interface circuit 620 or the RGB interface circuit 622, into the display data RAM 600.

Moreover, the control logic 624 decodes the control commands input from the host through the system interface circuit 620, and controls each part in the source driver 520 by outputting control signals that correspond to the decoding results. In the case where, for example, the control command indicates the read-out from the display data RAM 600, an output processing of the display data, which is read out from the display data RAM 600 with the read-out control, to the host through the system interface circuit 620, is performed.

Furthermore, the control logic 624 includes the driving mode setting register for setting the driving mode, and can perform a driving control according to a setting value of the driving mode setting register. In this case, the control logic 624 controls a display data latch circuit 608 and a driving circuit 650. The driving mode setting register is accessed by the host or the controller via the system interface circuit 620 or the RGB interface circuit 622.

The source driver 520 includes a display timing generation circuit 640 and an oscillation circuit 642. The display timing generation circuit 640 generates timing signals that are transmitted, from a display clock generated by the oscillation circuit 642, to the display data latch circuit 608, a line address circuit 610, the driving circuit 650, and a gate driver control circuit 630.

The gate driver control circuit 630 outputs the gate driver control signals (a clock signal CPV of one horizontal scanning period cycle, a start pulse signal STV that indicates the start of one vertical scanning period cycle, and a reset signal, etc.) in order to drive the gate driver 530, in correspondence to the control command from the host input via the system interface circuit 620.

A storage space of the display data stored in the display data RAM 600 is determined by a row address and a column address. The row address is specified by a row address circuit 602. The column address is specified by a column address circuit 604. The display data, input via the system interface circuit 620 or the RGB interface circuit 622, is written in to the storage space of the display data RAM 600 determined by the row address and the column address, after being buffered in an I/O buffer circuit 606. Moreover, the display data in the display data RAM 600, read out from the storage space that is determined by the row address and the column address, is output via the system interface circuit 620, after being buffered in an I/O buffer circuit 606.

The line address circuit 610 is synchronized with the clock signal CPV of one horizontal scanning period cycle in the gate driver control circuit 630, and it specifies a line address in order to read out the display data for outputting it to the driving circuit 650 from the display data RAM 600. The display data, read out from the display data RAM 600, is output to the driving circuit 650 after being latched in the display data latch circuit 608.

The driving circuit 650 includes a plurality of output circuits installed for every source line. Each output circuit drives a source line.

The source driver 520 includes an internal power circuit 660. The internal power circuit 660 generates voltages necessary for the liquid crystal display (a higher-potential-side power voltage VDDHS or a lower-potential-side power voltage VSS), using the power voltage supplied from the power circuit 542. The internal power circuit 660 includes a reference voltage generation circuit 662. In the reference voltage generation circuit 662, the higher-potential-side power voltage VDDHS and the lower-potential-side power voltage (system grounding power voltage) VSS are divided into plurality of grayscale voltages. For instance, if the size of display data for one dot is 6 bits, the reference voltage generation circuit 662 generates 64 kinds (=2⁶) of grayscale voltages V0 to V63. Each grayscale voltage corresponds to the display data. The driving circuit 650 transforms the signal amplitude of the digital display data, provided from the display data latch circuit 608, into the amplitude of the source voltage level of the driving system, and thereafter selects one of the plurality of grayscale voltages generated by the reference voltage generation circuit 662, based on this transformed signal, and consequently outputs an analog grayscale voltage, which corresponds to the digital display data, to the output circuit. Subsequently, the Op-Amp of the output circuit buffers these grayscale voltages and outputs them to the source lines, thereby driving the source lines. Here, the output circuit includes the voltage setting circuit. It also allows the voltage setting circuit to set a voltage that corresponds to a high bit of the display data as an output of the Op-Amp, without driving the Op-Amp. More specifically, the driving circuit 650 includes the Op-Amp and the voltage setting circuit, both of which are installed once per source line. In this driving circuit 650, each Op-Amp performs impedance transformation on the grayscale voltage and outputs it to each source line, or, each voltage setting circuit supplies the voltage, which corresponds to the high bit of the display data, to each source line.

1.2 Gate Driver

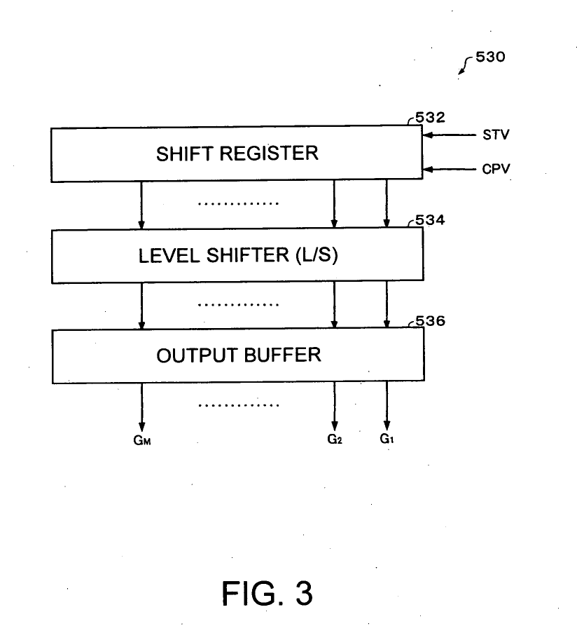

In FIG. 3, an example structure of the gate driver in FIG. 1 is shown.

The gate driver 530 includes a shift register 532, a level shifter 534, and an output buffer 536.

The shift register 532 is installed in correspondence with each gate line, and includes a plurality of flip-flops that are sequentially connected. The shift register 532 retains the start pulse signal STV in the flip-flop, in synchronization with the clock signal CPV from the gate driver control circuit 630. Thereafter, it sequentially shifts the start pulse signal STV to an adjacent flip-flop in synchronization with the clock signal CPV. The start pulse signal STV input here is a vertical synchronization signal from the gate driver control circuit 630.

The level shifter 534 shifts the voltage level, the voltage provided from the shift register 532, to the level of the voltage that corresponds to the transistor capacities of the liquid crystal element and the TFT. A high voltage level, from 20V to 50V for instance, is required for this voltage level.

The output buffer 536 buffers the scanned voltages shifted by the level shifter 534 and outputs them to the gate lines, thereby driving the gate lines.

2. Detailed Example Structure of Source Driver

2.1 First Example Structure

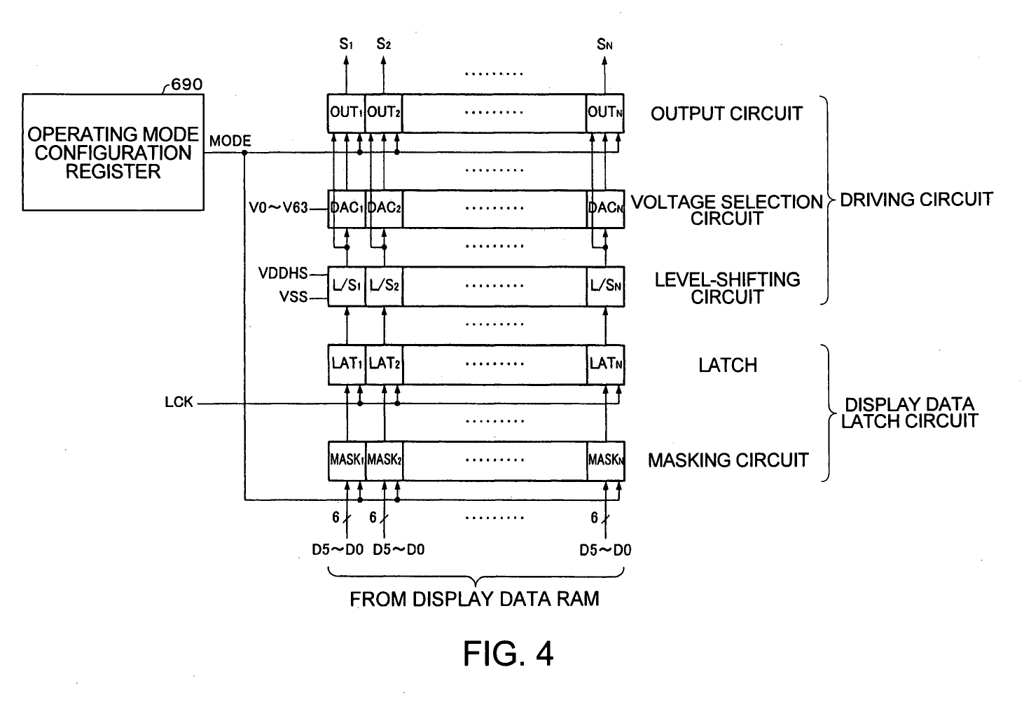

In FIG. 4, a block diagram of a main part of a source driver in a first example structure in the embodiment is shown. An example structure of the driving circuit 650 and of the display data latch circuit 608 of FIG. 2, is shown in FIG. 4. Further, the number of bits m per one dot in the display data is 6 (=6 bits), and the reference voltage generation circuit 662 generates the grayscale voltages V0 to V63.

The display data latch circuit 608 includes latches LAT₁ to LAT_{N}, and mask circuits MASK₁ to MASK_{N}. The structure of each of the latches LAT₁ to LAT_{N} is the same. The structure of each of the mask circuits MASK₁ to MASK_{N} is also the same.

The driving circuit 650 includes level shifting circuits L/S₁ to L/S_{N}, voltage selection circuits DAC₁ to DAC_{N}, and output circuits OUT₁ to OUT_{N}. The level shifting circuits L/S₁ to L/S_{N}, the voltage selection circuits DAC₁ to DAC_{N}, and the output circuits OUT₁ to OUT_{N} are respectively installed for every source line output. The structure of each of the level shifting circuits L/S₁ to L/S_{N} is the same. The structure of each of the voltage selection circuits DAC₁ to DAC_{N} is also the same. Further, the structure of each of the output circuits OUT₁ to OUT_{N} is also the same.

Hereafter, the circuit part that drives the source line S₁ is described. The same description also applies to the circuit parts that drive the source lines S₂ to S_{N}.

In the driving circuit 650 in FIG. 4, the level shifting circuit L/S₁, the voltage selection circuit DAC₁ and the output circuit OUT₁ are installed in correspondence to the source line S₁. The level shifting circuit L/S₁ transforms the signal's amplitude in the voltage level of each bit in the 6 bit of display data that corresponds to the source line S₁. More specifically, the signal's amplitude in each bit of the display data, input to the level shifting circuit L/S₁, is the amplitude of the low voltage (for instance, 1.8V) in the control logic system, and the amplitude of this signal is transformed into that of a high voltage (for instance, 5.0V) in the driving system. The voltage selection circuit DAC₁ generates one grayscale voltage that corresponds with the 6 bits of signal after the amplitude transformation (after the voltage level transformation), which is an output signal of the level shifting circuit L/S₁. More specifically, among the grayscale voltages V0 to V63, generated by the reference voltage generation circuit 662, one grayscale voltage that corresponds to the above-mentioned 6 bits of signal is selected and output to the output circuit OUT₁. Thereafter, the output circuit OUT₁ drives the source line S₁.

The output circuit OUT₁ includes the Op-Amp and the voltage setting circuit, where the Op-Amp or the voltage setting circuit supplies the voltage to the source line. The Op-Amp or the voltage setting circuit operates, based on a setting value of the driving mode setting register 690.

A driving mode signal MODE is input to the output circuit OUT₁. In correspondence to the driving mode signal MODE, the output circuit OUT₁ supplies the driving voltage to the source line with the Op-Amp or with the voltage setting circuit.

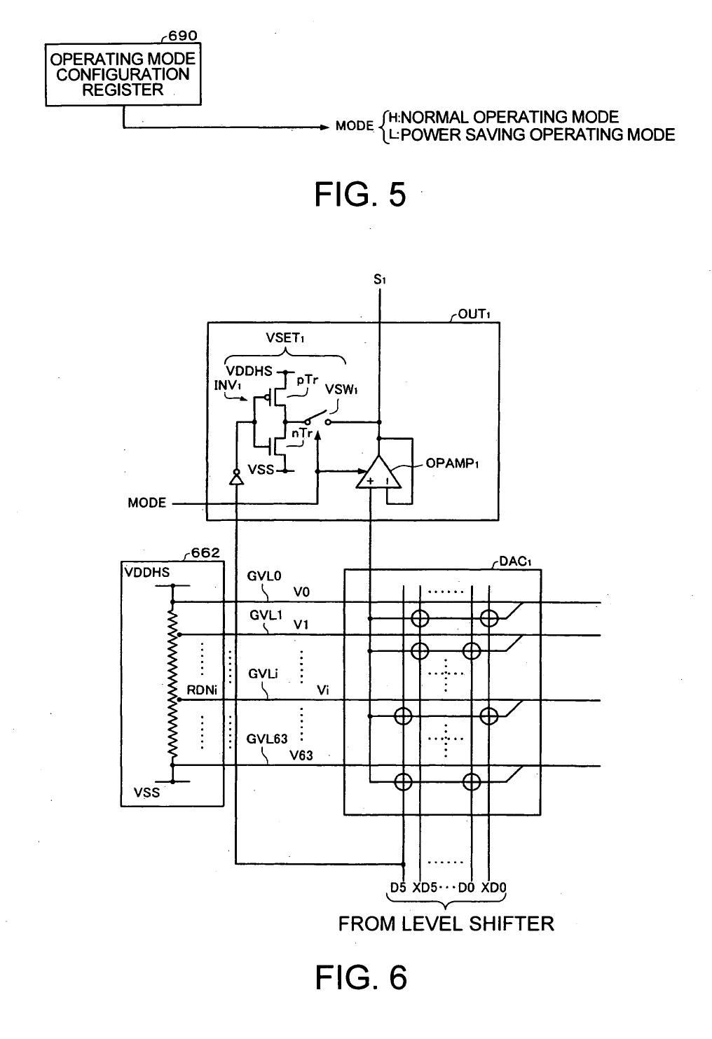

In FIG. 5, an explanatory drawing of the driving mode setting register 690, which outputs this driving mode signal MODE, is shown.

The driving mode setting register 690 is included in the control logic 624. A setting value of the driving mode setting register 690 is set by, for example, the host. If the normal driving mode (the first driving mode) is set by the driving mode setting register 690, the driving mode signal MODE is in level H. If the power saving driving mode (the second driving mode) is set by the driving mode setting register 690, the driving mode signal MODE is in level L.

In the output circuit OUT₁ in FIG. 4, the Op-Amp operates as the impedance transformer if the normal driving mode is set by the driving mode signal MODE. In other words, the Op-Amp drives the source line based on the grayscale voltage that corresponds to the 6 bits of display data. Here, the voltage setting circuit is electrically disconnected from the output of the Op-Amp.

In the output circuit OUT₁, if the power saving driving mode is set by the driving mode signal MODE, the operation of the Op-Amp ceases and the output of the output circuit OUT₁ is set to a high impedance status. At the same time, the voltage setting circuit sets the voltage, which corresponds to the higher-order n bits (n<m, n is a positive integer) of the display data, to the output of the Op-Amp. In this case, the variety of voltages output to the source line declines. For example, if the source lines S₁, S₂, and S₃ respectively represent Red, Green, and Blue components, each color component is expressed in one bit, resulting in color reduction. However, power consumption can be reduced since the operation of the Op-Amp can be ceased.

The signal of the display data, each display data being 6 bits long, the signal being taken into each of the latches LAT₁ to LAT_{N} of the display data latch circuit 608, is supplied to each of the level shifting circuits L/S₁ to L/S_{N} in the driving circuit 650 described above, as an input signal of each level shifting circuit. These latches LAT₁ to LAT_{N} take in the display data at the timing of a rise edge or a fall edge of a latch clock LCK provided from the display timing generation circuit 640. The latch clock LCK is generated by, for example, the display timing generation circuit 640.

The data supplied to the latches LAT₁ to LAT_{N}, is that of the data after the mask control, performed on the display data from the display data RAM 600 by the mask circuits MASK₁ to MASK_{N}. The mask circuits MASK₁ to MASK_{N} mask the lower-order (m-n) bits of data of the display data, excluding the higher-order n bits of data, based on the driving mode signal MODE.

Meanwhile, the transformation of voltage level involves current consumption in the level shifting circuit L/S₁, as described later. In other words, the transformation of voltage level brings about current consumption, which is equivalent to the number of bits of the display data, in the level shifting circuit L/S₁.

Thus, in the first example structure, the current consumption is reduced by not transforming the signal's voltage level of the lower-order (m-n) bits of the display data, by focusing on the fact that only the higher-order n bits of the display data are used in the power saving driving mode. More specifically, when the power saving driving mode is set by the driving mode setting register 690, the input signals of the level shifters, which transform the voltage level of each signal corresponding to each of the lower-order (m-n) bits, are fixed (for instance, to level H or level L). That is to say, if the power saving driving mode is set, the input signals of the first to (m-n)-th level shifters, out of the first to m-th level shifters, are fixed. Consequently, the generation of the through current, generated upon the transformation of the voltage level, is suppressed, thereby the current consumption is reduced. In order to achieve the above, the lower-order (m-n) bits of display data are masked in each mask circuit, thereby fixing the display data taken into each latch. Hence, the input signals of the lower-order (m-n) bits that respectively correspond to each of the level shifting circuits, can be fixed. Here, it is preferable that the value of n be 1. The smaller n is, more omission of the unnecessary drive of Op-Amp is allowed.

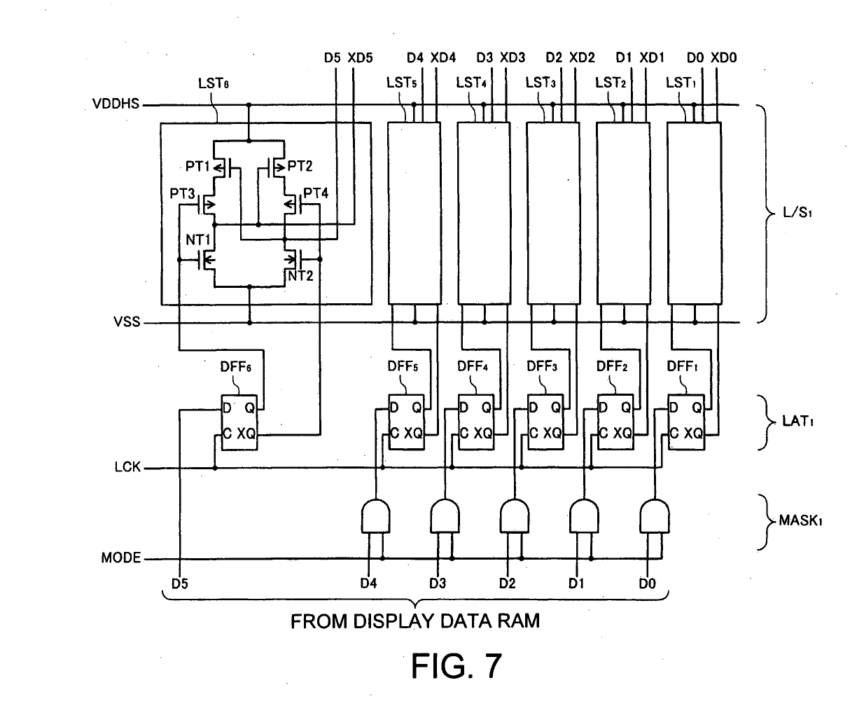

In FIGS. 6 and 7, detailed example structures of a circuit for one output described in FIG. 4 are shown.

In FIGS. 6 and 7, the example structures of a circuit that drives the source line S₁ are shown. In FIG. 6, the example structure of the output circuit OUT₁ and the voltage selection circuit DAC₁ is shown. In FIG. 7, the example structure of the level shifting circuit L/S₁, the latch LAT₁, and the mask circuit MASK₁, is shown. Here, the example structure of the circuit that drives the source line S₁ is shown. However, the same description also applies to the structures of other circuits that drive other source lines. Hereafter, the voltage setting circuit sets the voltage that corresponds to the most significant bit (where n is 1 in “the higher-order n bits”) out of 6 bits of the display data, to the output of the Op-Amp, in the power saving driving mode.

An Op-Amp OPAMP₁ in the output circuit OUT₁, is an operational amplifier in which a voltage follower is connected. The output of the Op-Amp OPAMP₁ is electrically connected to the source line S₁. The grayscale voltage from the voltage selection circuit DAC₁ is supplied as the input of the Op-Amp OPAMP₁. The driving mode signal MODE performs the operational cease control of the Op-Amp OPAMP₁. If the operation is ceased, its output is set to a high impedance state. The structure of above-mentioned Op-Amp OPAMP₁ is generally common, thus its explanation is omitted.

A voltage setting circuit VSET₁ in the output circuit OUT₁ includes a switching element VSW₁ and an inverter circuit INV₁. The inverter circuit INV₁ includes a p-type (a first conduction type) Metal Oxide Semiconductor (hereafter “MOS”) transistor pTr and an n-type (a second conduction type) MOS transistor nTr. The higher-potential-side power voltage VDDHS is supplied to the source of the transistor pTr, and the data D5's inverted signal, where the data D5 is the most significant bit of the display data, is supplied to the gate. The inverted signal of the data D5 is, in other words, a signal of the data D5's inverted data XD5, where the data D5 is the most significant bit. The lower-potential-side power voltage VSS is supplied to the source of the transistor nTr, and the data D5's inverted signal (or the display data XD5's signal), where the data D5 is of the most significant bit of the display data, is supplied to the gate. The drain of transistor pTr and the drain of the transistor nTr are connected. The switching element VSW₁ is inserted between the output of the Op-Amp OPAMP₁ and the drains of transistors pTr and nTr. The on-off control is performed on the switching element VSW₁, based on the driving mode signal MODE. More specifically, based on the driving mode signal MODE, if the switching element VSW₁ is in a conductive status, the output of the Op-Amp OPAMP₁ is set to the high impedance state. If the switching element VSW₁ is in a non-conductive status, the Op-Amp OPAMP₁ starts the impedance transformation and drives its output.

The display data D0 to D5 (including the inverted data XD0 to XD5 thereof) provided from the display data latch circuit 608, is input to the voltage selection circuit DAC₁. Moreover, the grayscale voltage signal lines GVL0 to GVL63, led from the reference voltage generation circuit 662, are connected to the voltage selection circuit DAC₁. The grayscale voltages V0 to V63 are supplied to the grayscale voltage signal lines GVL0 to GVL63. Moreover, the voltage selection circuit DAC₁ selects the grayscale voltage signal lines that correspond to the display data D0 to D5 and XD0 to XD5, and electrically connects the signal lines to the input of the Op-Amp OPAMP₁. Consequently, the grayscale voltage, selected by the voltage selection circuit DAC₁, can be supplied to the input of the Op-Amp OPAMP₁.

Here, the reference voltage generation circuit 662 includes a gamma correction resistor. The gamma correction resistor outputs the divided voltage Vi (0≦i≦63, where i is an integer) which actually is the grayscale voltage Vi into the resistor-dividing-node RDNi, where the divided voltage Vi is a voltage which is, between the higher-potential-side power voltage VDDHS and the lower-potential-side power voltage VSS, divided with a resistor. The grayscale voltage Vi is supplied to the grayscale voltage signal line GVLi.

In FIG. 7, the level shifting circuit L/S₁ includes the first to sixth (where 1 to 6 are the possible values for m in “m-th level shifter”) level shifters LST₁ to LST₆. The amplitude of each level shifter's input signal is, for example, 1.8V. The voltage between the higher-potential-side power voltage VDDHS and the lower-potential-side power voltage VSS is, for example, 5.0V. Signals for the least significant bit's data D0 among 6 bits of display data D5 to D0, and for the D0's inverted data XD0 are supplied as input signals to the first level shifter LST₁. Signals for data D1 of the second bit from the least significant bit among 6-bit display data D5 to D0, and for the D1's inverted data XD1 are supplied as input signals to the second level shifter LST₂. Similarly, the signal for the most significant bit's data D5, out of 6 sets of display data D5 to D0 corresponding to 6 bits, and a signal for the D5's inverted data XD5, are supplied as input signals to the sixth level shifter LST₆.

The input signals for the first to sixth level shifters LST₁ to LST₆ are taken to the latch LAT₁. The LAT₁ has first to sixth D-type flip-flops DFF₁ to DFF₆ (or first to sixth latches). The latch clock LCK is supplied to each of the D-type flip-flops.

The signal for the data D5, where the data D5 is the most significant bit of the display data, is input to a data input terminal of the sixth D-type flip-flop DFF₆, among the first to sixth D-type flip-flops DFF₁ to DFF₆. The signals for the sets of display data D4 to D0 are input to the data input terminals of the first to fifth D-type flip-flop DFF₁ to DFF₅, among the first to sixth D-type flip-flops DFF₁ to DFF₆. Here, the sets of display data D4 to D0 are provided from the display data RAM 600, in which the data is mask-controlled by the mask circuit MASK₁.

The mask circuit MASK₁ conducts the mask control of the sets of display data D4 to D0, based on the driving mode signal MODE. More specifically, if the power saving driving mode is set by the driving mode signal MODE, the mask circuit MASK₁ masks the sets of display data D4 to D0 and fixes them to level L. In FIG. 7, the level L is fixed using an AND logic operation circuit. However, an OR logic operation circuit may also be used to fix to the level H.

The structure of each level shifter is the same; thus, hereafter, the structure of the sixth level shifter LST₆ is described. In the sixth level shifter LST₆, the higher-potential-side power voltage VDDHS is supplied to the sources of p-type MOS transistors PT1 and PT2. The sources of p-type MOS transistors PT3 and PT4 are connected to the drains of the p-type MOS transistors PT1 and PT2. The drains of n-type MOS transistors NT1 and NT2 are connected to the drains of the p-type MOS transistors PT3 and PT4. The lower-potential-side power voltage VSS is supplied to the sources of the n-type MOS transistors NT1 and NT2. The gate of the p-type MOS transistor PT 1 is connected to the drain of the n-type MOS transistor NT2. The gate of the p-type MOS transistor PT 2 is connected to the drain of the n-type MOS transistor NT1. A signal of the data D5, where the data D5 is the most significant bit of the display data, is supplied to the gates of the p-type MOS transistor PT3 and the n-type MOS transistor NT1. A signal of the inverted data XD5, the inverted data XD5 being the display data's most significant bit, is supplied to the gates of the p-type MOS transistor PT4 and the n-type MOS transistor NT2. Thereafter, drain voltage of the n-type MOS transistor NT2 is output to the voltage selection circuit DAC₁, as a signal of the most significant bit's data D5 after the voltage level transformation. Further, drain voltage of the n-type MOS transistor NT1 is output to the voltage selection circuit DAC₁, as a signal of the most significant bit's inverted data XD5, after the voltage level transformation.

In the above-mentioned structure, if the data D5 of the display data's most significant bit is in level H, the inverted data XD5 thereof is in level L. Consequently, the n-type MOS transistor NT1 is switched on, and the p-type MOS transistor PT3 is switched off. Further, the p-type MOS transistor PT2 is switched on, and the signal of the inverted data XD5 after the voltage level transformation becomes approximately that of the lower-potential-side power voltage VSS. Still further, the n-type MOS transistor NT2 is switched off, and the p-type MOS transistor PT4 is switched on. Furthermore, the p-type MOS transistor PT1 is switched off, and the signal of the data D5 after the voltage level transformation, where the data D5 is the display data's most significant bit, becomes approximately that of the higher-potential-side power voltage VDDHS.

On the other hand, if the data D5 of the display data's most significant bit is in level L, the inverted data XD5 thereof is in level H. Consequently, the n-type MOS transistor NT2 is switched on, and the p-type MOS transistor PT4 is switched off. Further, the p-type MOS transistor PT1 is switched on, and the signal of the data D5 after the voltage level transformation, where the data D5 is the display data's most significant bit, becomes approximately that of the lower-potential-side power voltage VSS. Furthermore, the n-type MOS transistor NT1 is switched off, and the p-type MOS transistor PT3 is switched on. Still further, the p-type MOS transistor PT2 is switched off, and the signal of the inverted data XD5 after the voltage level transformation becomes approximately that of the higher-potential-side power voltage VDDHS.

In the sixth level shifter LST₆ with such a structure, the data D5 and its inverted data XD5 are both fixed, where the data D5 is the most significant bit of the display data. In this status, gate signals for n-type MOS transistors NT1, NT2, and p-type MOS transistors PT3, PT4, are fixed. Consequently, the through current does not occur and there is no current consumption. However, in the case where the sets of data for the data D5 and its inverted data XD5 change, where the data D5 is the display data's most significant bit, through currents are generated. One through current runs through the p-type MOS transistors PT1 and PT3, and n-type MOS transistor NT1, and another through current runs p-type MOS transistor PT2 and PT4, and n-type MOS transistor NT3. Consequently, in the sixth level shifter LST₆, power is consumed by the generation of the through current, when the input signal changes.

Therefore, if the normal driving mode is set by the driving mode signal MODE, the display data's signals, provided from the display data RAM 600, are taken into the first to sixth D-type flip-flops DFF₁ to DFF₆ in the latch LAT₁. Thereafter, the signals after the voltage level transformations of the first to sixth level shifters LST₁ to LST₆ are supplied to the voltage selection circuit DAC₁.

On the other hand, if the power saving driving mode is set by the driving mode signal MODE, the signals taken into the first to fifth D-type flip-flops DFF₁ to DFF₅ in the latch LAT₁ are fixed to the level L or the level H. Hence the input signals of the first to fifth level shifters LST₁ to LST₅ do not change, resulting in no power consumption in the first to fifth level shifters LST₁ to LST₅. Only the input signal of the sixth level shifter LST₆ changes, and is utilized in the voltage setting for the source line, based on the most significant bit of the display data. More specifically, the voltage setting circuit VSET₁ sets the voltages to the output of the Op-Amp OPAMP₁, the voltages corresponding to the output signals of the (m-n+1)-th to m-th level shifters, where in FIGS. 6 and 7, m is 6 and n is 1. Consequently, the power saving driving mode allows to reduce the amount of excessive power consumption involved in the voltage level transformation.

2.2 Second Example Structure

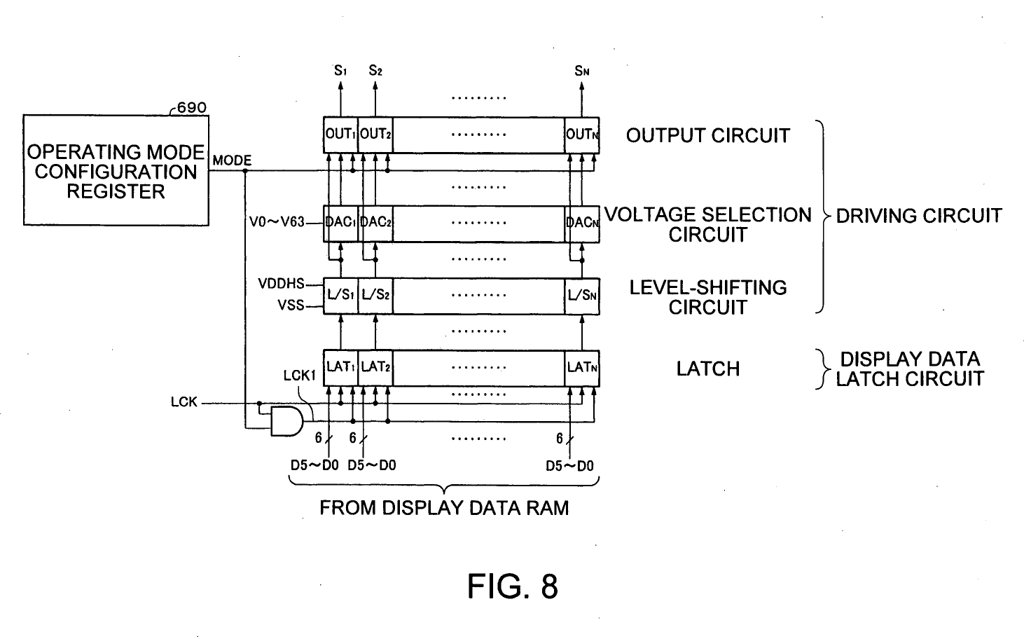

In FIG. 8, a block diagram of a main part of a source driver in a second example structure in the embodiment is shown. The same signs and numerals are used for the same parts as in FIG. 4, and their descriptions are omitted in FIG. 8.

The differences found in the second example structure shown in FIG. 8, when compared to the first example structure shown in FIG. 4, are that: the mask circuits MASK₁ to MASK_{N} are omitted, and the latch clock mask-controlled by the driving mode signal MODE is supplied to the latches LAT₁ to LAT_{N}.

In other words, the display data from the display data RAM 600 is directly supplied to the latches LAT₁ to LAT_{N}, without being mask-controlled by the mask circuit. Moreover, besides the latch clock LCK, a latch clock LCK1, in which the latch clock LCK is mask-controlled by the driving mode signal MODE, is supplied to each of the latches LAT₁ to LAT_{N}. Therefore, if the power saving driving mode is set, the latch clock of the first to (m-n)-th latches among the first to m-th latches, are fixed.

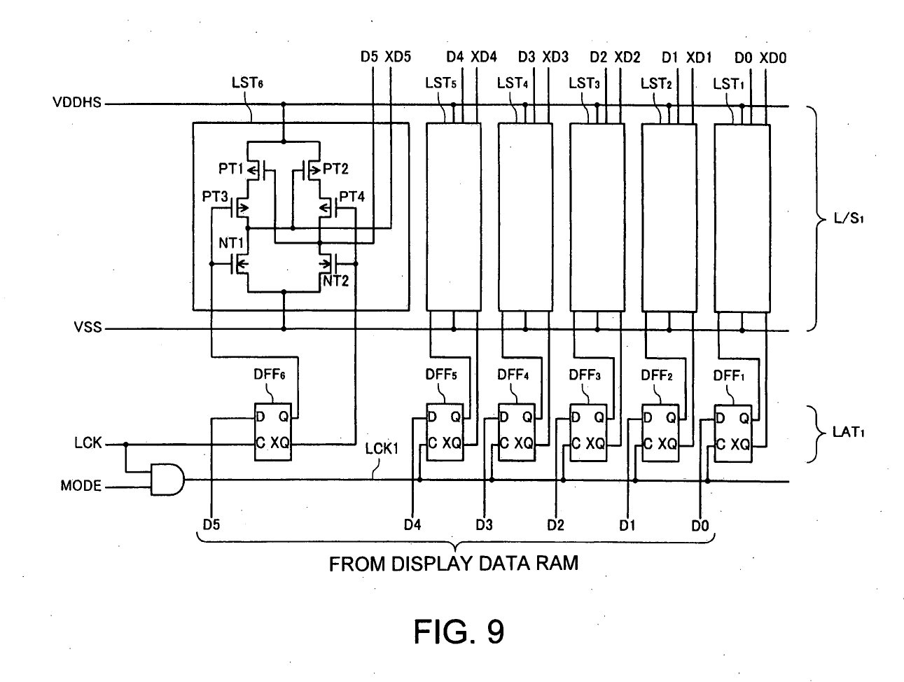

In FIG. 9, a specific example structure of a circuit for one output in FIG. 8 is shown. The structures of the output circuit and the voltage selection circuit are similar to that of the first example structure shown in FIG. 6, hence the drawing of those circuits and the description thereof are omitted. Moreover, in FIG. 9, the same signs and numerals are used for the same parts as in FIG. 7, and their descriptions are omitted appropriately.

In the second example structure, the latch clock LCK is supplied to a clock terminal of the sixth D-type flip-flop DFF₆. Moreover, the latch clock LCK1, in which the latch clock LCK is mask-controlled by the driving mode signal MODE, is supplied to the clock terminals of the first to fifth D-type flip-flops DFF₁ to DFF₅. More specifically, if the power saving driving mode is set by the driving mode signal MODE, the latch clock LCK1 is fixed to level L. In FIG. 9, the level L is fixed using an AND logic operation circuit. However, an OR logic operation circuit may also be used to fix to the level H.

Therefore, if the normal driving mode is set by the driving mode signal MODE, the latch clock LCK is not masked. Therefore, the display data's signals, provided from the display data RAM 600, are taken into the first to sixth D-type flip-flops DFF₁ to DFF₆ of the latch LATE. Thereafter, the signals after the voltage level transformations of the first to sixth level shifters LST₁ to LST₆ are supplied to the voltage selection circuit DAC₁.

On the other hand, if the power saving driving mode is set by the driving mode signal MODE, the latch clock LCK1 is fixed to level L. Therefore, new signals are not taken into the first to fifth D-type flip-flops DFF₁ to DFF₅ in the latch LATE. Hence the input signals of the first to fifth level shifters LST₁ to LST₅ do not change, resulting in no power consumption in the first to fifth level shifters LST₁ to LST₅. Only the input signal of the sixth level shifter LST₆ changes, and is utilized in the voltage setting for the source line, based on the most significant bit of the display data. More specifically, the voltage setting circuit VSET₁ sets the voltages to the output of the Op-Amp OPAMP₁, the voltages corresponding to the output signals of the (m-n+1)-th to m-th level shifters, where in FIGS. 6 and 7, m is 6 and n is 1. Consequently, the power saving driving mode allows to reduce the amount of excessive power consumption involved in the voltage level transformation.

2.3 Third Example Structure

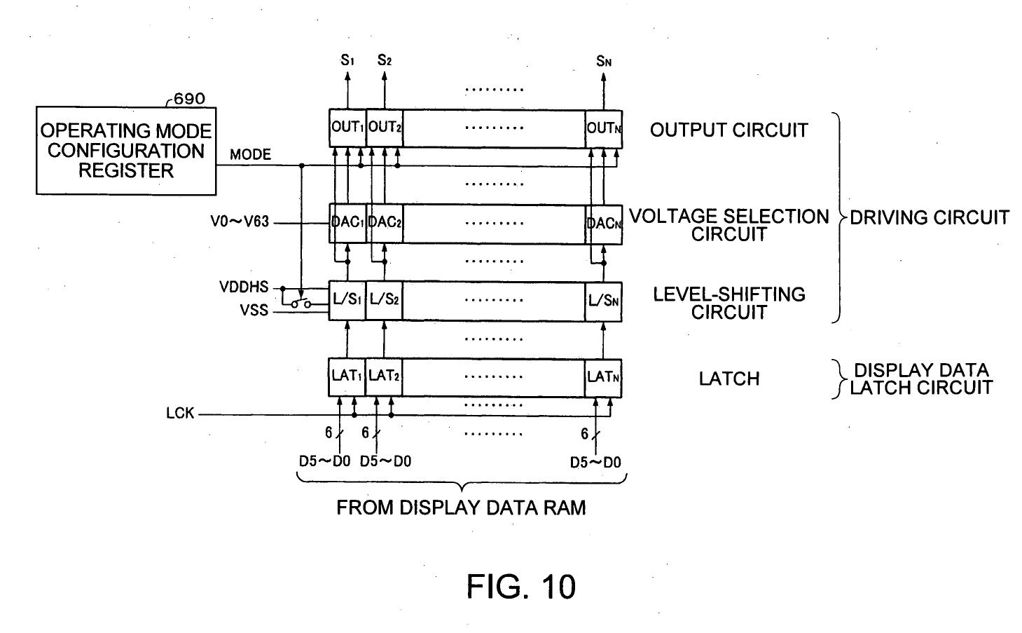

In FIG. 10, a block diagram of a main part of a source driver in a third example structure in the embodiment is shown. The same signs and numerals are used for the same parts as in FIG. 4, and their descriptions are omitted appropriately in FIG. 10.

The differences found in the third example structure shown in FIG. 10, when compared to the first example structure shown in FIG. 4, are that: the mask circuits MASK₁ to MASK_{N} are omitted, and cease control in the supply of the higher-potential-side power voltage or the lower-potential-side power voltage to the level shifting circuits L/S₁ to L/S_{N} is conducted, based on the driving mode signal MODE.

In other words, the display data from the display data RAM 600 is directly supplied to the latches LAT₁ to LAT_{N}, without being mask-controlled by the mask circuit. The cease control in the supply of the higher-potential-side power voltage or the lower-potential-side power voltage is conducted on the level shifting circuits L/S₁ to L/S_{N}.

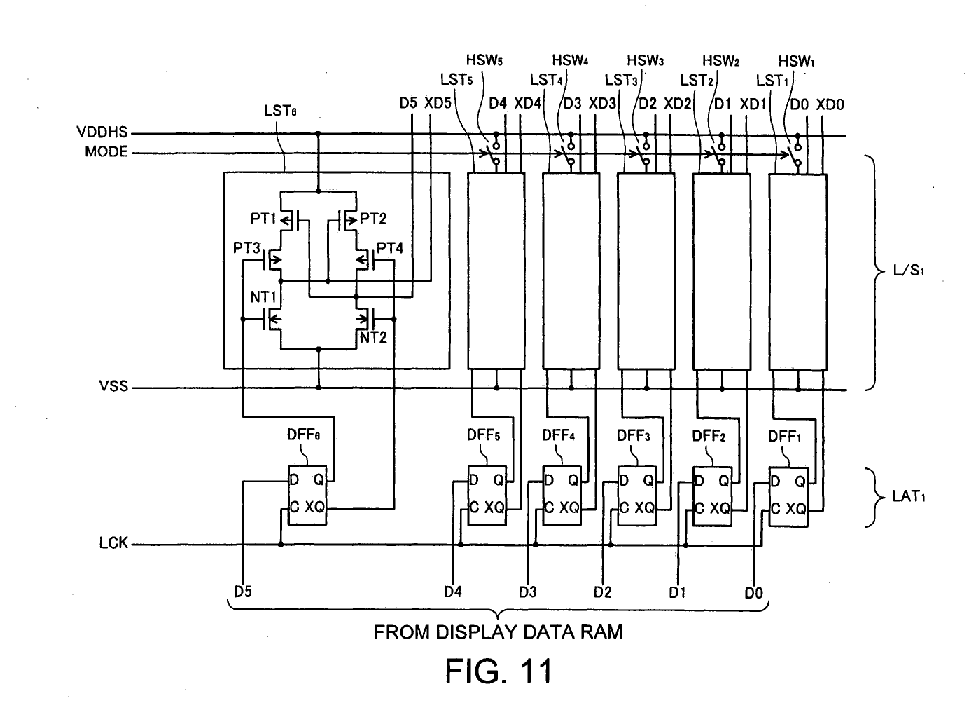

In FIG. 11, a specific example structure of a circuit for one output in FIG. 10 is shown. The structures of the output circuit and the voltage selection circuit are similar to that of the first example structure shown in FIG. 6, hence the drawing of those circuits and the description thereof are omitted. Moreover, in FIG. 9, the same signs and numerals are used for the same parts as in FIG. 7, and their descriptions are omitted appropriately.

In a third example structure, regardless of the driving modes set by the driving mode signal MODE, the higher-potential-side power voltage is supplied to the sixth level shifter LST₆. In each of the first to fifth level shifters LST₁ to LST₅, the sources of the p-type MOS transistors PT1 and PT2 are connected, via switching elements, and via the power source line where the higher-potential-side power voltage VDDHS is supplied. In other words, the sources of the p-type MOS transistors PT1 and PT2 at the fifth level shifter LST₅, are connected via a switching element HSW₅ to the power source line, where the higher-potential-side power voltage VDDHS is supplied. The sources of the p-type MOS transistors PT1 and PT2 at the fourth level shifter LST₄, are connected via a switching element HSW₄ to the power source line, where the higher-potential-side power voltage VDDHS is supplied. Similarly, the sources of the p-type MOS transistors PT1 and PT2 at the first level shifter LST₁, are connected via a switching element HSW₁ to the power source line, where the higher-potential-side power voltage VDDHS is supplied.

The switching elements HSW₁ to HSW₅ are in a conductive status (switched on) if the normal driving mode is set by the driving mode signal MODE, and are in non-conductive status (switched off) if the power saving driving mode is set by the driving mode signal MODE.

Thus, the higher-potential-side power voltage is supplied to the first to sixth level shifters LST₁ to LST₆ when the normal driving mode is set by the driving mode signal MODE. Consequently, the signals of the first to sixth level shifters LST₁ to LST₆ after the voltage level transformation are supplied to the voltage selection circuit DAC.

On the other hand, when the power saving driving mode is set by the driving mode signal MODE, the supply of the higher-potential-side power voltage to the first to fifth level shifters LST₁ to LST₅ ceases. Consequently, there is no power consumption in the first to fifth level shifters LST₁ to LST₅. Therefore, if the power saving driving mode is set, the supply of the higher-potential-side power voltage or the lower-potential-side power voltage to the first to (m-n)-th level shifters among the first to m-th level shifters, ceases.

Only the input signal of the sixth level shifter LST₆ changes, and is utilized in the voltage setting for the source line, based on the most significant bit of the display data. More specifically, the voltage setting circuit VSET₁ sets the voltages to the output of the Op-Amp OPAMP₁, the voltages corresponding to the output signals of the (m-n+1)-th to m-th level shifters, where in FIGS. 6 and 7, m is 6 and n is 1. Consequently, the power saving driving mode allows to reduce the amount of excessive power consumption involved in the voltage level transformation.

In the third example structure, the switching elements HSW₁ to HSW₅ allow to cease the supply of the higher-potential-side power voltage to the first to fifth level shifters LST₁ to LST₅. However, the supply of lower-potential-side power voltage may be ceased by installing similar switches.

3. Electronic Instruments

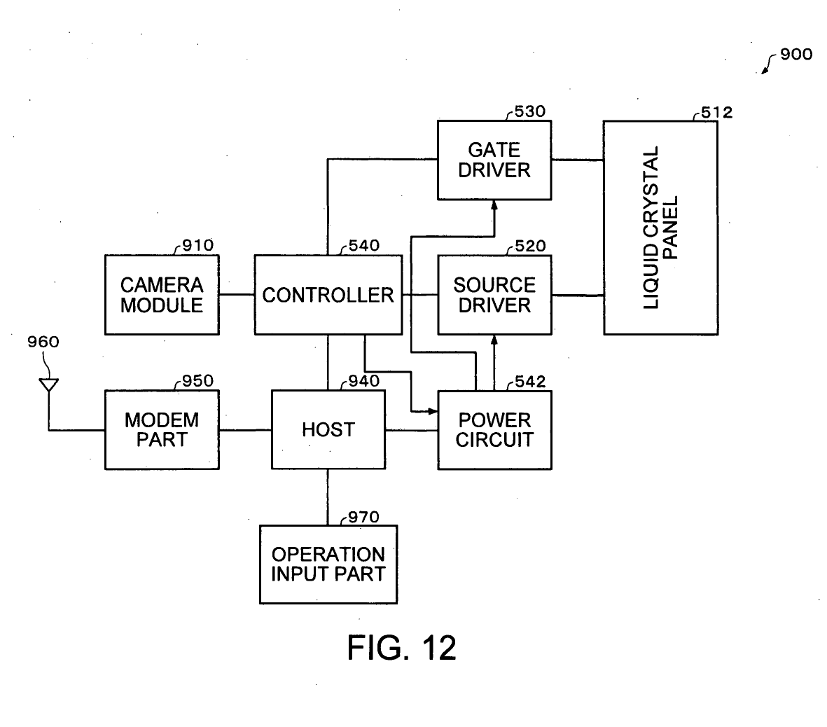

In FIG. 12, a block diagram of an example structure of an electronic instrument in the embodiment is shown. Here, a mobile phone is shown in the block diagram as an example of the electronic instrument. The same signs and numerals are used for the same parts as in FIG. 1, and their descriptions are omitted appropriately in FIG. 12.

A mobile phone 900 includes a camera module 910. The camera module 910 includes a charged-coupled device (hereafter CCD) camera, and supplies image data captured by the CCD camera to the controller 540 in a YUV format.

The mobile phone 900 includes a liquid crystal panel 512. The liquid crystal panel 512 is driven by the source driver 520 and the gate driver 530. The liquid crystal panel 512 includes a plurality of gate lines, source lines, and pixels.

The controller 540 is connected to the source driver 520 and to the gate driver 530, and supplies the display data in RGB format to the source driver 520.

The power circuit 542 is connected to the source driver 520 and to the gate driver 530, and supplies the driving power voltage to each of the drivers.

A host 940 is connected to the controller 540, and controls the it. Further, the host 940 can demodulate the display data received through an antenna 960 in a modem part 950, and can subsequently supply it to the controller 540. The controller 540 displays an image on the liquid crystal panel 512, using the source driver 520 and the gate driver 530, based on this display data.

The host 940 can modulate the display data generated by the camera module 910 at the modem part 950, and can subsequently command the transmission of the modulated data to another communication device through the antenna 960.

The host 940 conducts the send/receive processing of the display data, the imaging in the camera module 910, and the display processing of the liquid crystal panel 512, based on the operational information from an operation input part 970.

The present invention shall not be limited to the embodiments mentioned above, and within the main scope of the present invention, it is possible to embody the present invention with other kinds of modifications. For example, the invention can be applied, not only to the driving of the above-mentioned liquid crystal display panel, but also to the driving of an electro-luminescence or plasma display device.

The dependent claims of the invention may also include a structure, where some requirements in claims, to which dependent claims subordinate, are omitted. Moreover, the main scope of one independent claim in the invention can be subordinated to another independent claim.

Although only some embodiments of the invention have been described in detail above, those skilled in the art will readily appreciate that many modifications are possible in the embodiments without departing from the novel teachings and advantages of this invention. Accordingly, all such modifications are intended to be included within the scope of this invention.

What is claimed is:

1. A source driver which drives a source line of an electro-optic device, the source driver comprising:
a driving mode setting register which sets a first or a second driving mode;
first to m-th level shifters, each of which transforms a signal amplitude of each bit of m-bit display data (m is an integer larger than 1);
an Op-Amp which drives a source line based on one grayscale voltage that corresponds to output signals from the first to m-th level shifters, when the first driving mode is set by the driving mode setting register; and
a voltage setting circuit which sets a voltage as an output of the Op-Amp, the voltage corresponding to the higher-order n bits of data in the m-bit display data (n<m, and n is an integer), when the second driving mode is set by the driving mode setting register,
wherein an input signal of the first to (m-n)-th level shifters among the first to m-th level shifters is fixed, the first to (m-n)-th level shifters transforming a signal amplitude of each bit of the lower-order (m-n) bits of the m-bit display data, when the second driving mode is set.

2. A source driver which drives a source line of an electro-optic device, the source driver comprising:
a driving mode setting register which sets a first or a second driving mode;
first to m-th latches which take in m-bit display data at a timing of a rise edge or a fall edge of a latch clock (m is an integer larger than 1);
first to m-th level shifters, each of which transforms a signal amplitude of each bit of the m-bit display data taken by the first to m-th latches;
an Op-Amp which drives a source line based on one grayscale voltage that corresponds to output signals from the first to m-th level shifters, when the first driving mode is set by the driving mode setting register; and
a voltage setting circuit which sets a voltage as an output of the Op-Amp, the voltage corresponding to the higher-order n bits of data in the m-bit display data (n<m, and n is an integer), when the second driving mode is set by the driving mode setting register,
wherein a latch clock of the first to (m-n)-th latches among the first to m-th latches is fixed, the first to (m-n)-th latches taking in data of each bit in the lower-order (m-n) bits of the m-bit display data, when the second driving mode is set.

3. A source driver which drives a source line of an electro-optic device, the source driver comprising:
a driving mode setting register which sets a first or a second driving mode;
first to m-th level shifters, each of which transforms a signal amplitude of each bit of m-bit display data (m is an integer larger than 1);
an Op-Amp which drives a source line based on one grayscale voltage that corresponds to output signals from the first to m-th level shifters, when the first driving mode is set by the driving mode setting register; and
a voltage setting circuit which sets a voltage as an output of the Op-Amp, the voltage corresponding to the higher-order n bits of data in the m-bit display data (n<m, and n is an integer), when the second driving mode is set by the driving mode setting register,
wherein supply of a higher-potential-side power voltage or a lower-potential-side power voltage of the first to (m-n)-th level shifters among the first to m-th level shifters is stopped, the first to (m-n)-th level shifters transforming a signal amplitude of each bit in the lower-order (m-n) bits of the m-bit display data, when the second driving mode is set.

4. The source driver as defined in claim 1, further comprising:
a voltage selection circuit which selects one grayscale voltage from among 2^{m} types of grayscale voltages, in correspondence to the output signals from the first to m-th level shifters,
wherein the Op-Amp drives the source line based on the grayscale voltage selected by the voltage selection circuit.

5. The source driver as defined in claim 1,
wherein the voltage setting circuit sets a voltage as an output of the Op-Amp, the voltage corresponding to the output signals of the (m-n+1)-th to m-th level shifters.

6. The source driver as defined in claim 1, wherein n is 1.

7. An electro-optic device comprising:
a plurality of source lines;
a plurality of gate lines;
a pixel determined by one of the gate lines and one of the source lines;
a gate driver which scans the gate lines; and
the source driver as defined in claim 1, which drives each of the source lines.

8. An electronic instrument comprising the electro-optic device as defined in claim 7.
